(19) United States
(12) Patent Application Publication
(10) Pub. No.: US 2025/0010198 A1
(43) Pub. Date: Jan. 9, 2025

(54) Performance Based Gamification Platform

(71) Applicant: Milind S Bharvirkar, 12219 Pescara Lane, FL (US)

(72) Inventor: Milind S Bharvirkar, 12219 Pescara Lane, FL (US)

(21) Appl. No.: 18/219,675

(22) Filed: Jul. 8, 2023

(51) Int. Cl. A63F 13/61; A63F 13/792

(52) U.S. Cl. CPC A63F 13/61; A63F 13/792

(57) ABSTRACT

A performance-based gamification platform (PBGP) for a multitude of gaming types such as mobile devices, consoles, arcade games and home computers is disclosed. The PBGP incentivizes customer awareness and enhances merchant visibility by allowing multiple commercial brands to sponsor tournaments, sweepstakes, scavenger hunts, etc. Using the PBGP, players can receive online game credits to enter a select number of brand game promotions. Players can select their favorite sponsors. After the game play is over, the player can be rewarded with a prize or offer from the sponsor. Players can also be issued loyalty points for activities such as playing the sponsor's promotion, answering survey questions, or purchasing products. The sponsors can be charged when a player engages their game promotion or purchases their product. The gamification platform (e.g. GO4) is a turnkey solution that can make it cost effective for advertisers to engage gamers across multiple gaming environments. An object of the claimed PBGP is to enhance brand awareness within the various gaming communities.

### CROSS-REFERENCE TO RELATED APPLICATIONS

The present application includes subject matter disclosed in and claims priority to a provisional application entitled “Performance Based Gamification Platform” filed Jan. 11, 2023 and assigned Ser. No. 63/438,382 describing an invention made by the present inventor.

### FIELD OF THE INVENTION

The present invention relates to gaming. More specifically it relates to a prize and loyalty social game network for multiple forms of digital games.

### BACKGROUND

The term “gamification” first appeared online in the context of computer software in 2008. Gamification did not gain popularity until 2010. Other fields borrowing elements from videogames became common; for example, some work in learning disabilities and scientific visualization adapted elements from videogames. The term “gamification” first gained widespread usage in 2010, in a more specific sense referring to incorporation of social/reward aspects of games into software. The technique captured the attention of venture capitalists, one of whom said he considered gamification the most promising area in gaming. Another observed that half of all companies seeking funding for consumer software applications mentioned game design in their presentations. In addition to companies that use the technique, a number of businesses created gamification platforms. In October 2007, Bunchball, backed by Adobe Systems Incorporated, was the first company to provide game mechanics as a service, on Dunder Mifflin Infinity, the community site for the NBC TV show The Office. Bunchball customers have included Playboy, Chiquita, Bravo, and The USA Network. Badgeville, which offers gamification services, launched in late 2010, and raised $15 million in venture-capital funding in its first year of operation. Gamification as an educational and behavior modification tool reached the public sector by 2012, when the United States Department of Energy co-funded multiple research trials, including consumer behavior studies, adapting the format of Programmed learning into mobile microlearning to experiment with the impacts of gamification in reducing energy use.

Today, while the popularity of arcade games has declined somewhat with the rise of home video game consoles and mobile gaming, they are still found in many public places and are enjoyed by players of all ages. Many brands and advertisers have created their own game apps to engage game players and distribute product offers. Yet, these advertiser-based game apps are not very successful because they lack the quality and fun that popular mobile app games have. The industry needs a platform that allows brands to engage gamers with free to play prize promotions in successful video games on the app stores. The PBGP allows brands to drive their own prize promotions through existing games in the market, and brands can be charged when a player engages with their brand. This allows brands to engage millions of gamers on a pay per engagement basis. It also allows brands to measure their return on investment in any game, because the PBGP measures engagements and product purchases. United States Patent No. US20150005059A1 disclosed a system for promoting events across gaming machines; however, it is designed for casinos and not mobile gaming apps. United States Patent No. US20180240304A1 disclosed promotional events for mobile devices; however, it is not free for players. United States Patent No. US20180211486A1 disclosed a mobile app promotional platform; however, it is location dependent. United States Patent No. US20150142539A1 disclosed a gaming and tournament system for app games; however, it relies on luck and not skill-based games.

### SUMMARY OF THE INVENTION

The device herein disclosed and described provides a solution to the shortcomings in the prior art through the disclosure of a PBGP. An object of the PBGP is to incentivize customer awareness and enhance merchant visibility by allowing commercial brands to organize free to play prize promotions across gaming platforms. PBGP allows players to play their favorite games to win prizes from their favorite brands. PBGP offers players a certain amount of free game credits. Players can choose their favorite prizes when playing. This feature tells the PBGP which products the player enjoys playing for. After each event is played, the player can receive points and/or an offer for the product they selected. The player can simply click two buttons and the purchase can be made with the GO4 app. The product can be shipped or redeemed at retail locations with a QR code. The PBGP system can automatically pay the retailer or advertiser for any purchases made on the app. The PBGP can give advertisers a measurement of their return on investment for their advertising via an online dashboard and analytic landing page.

Another object of the invention is a web portal or app that allows brands the means to create game promotions within different games to reach potential customers. Business owners have tools to customize their promotion with prizes, offers, points or select geographic area, or hyper target people based on demographics or preferences. For example, an online clothing store uses the platform to create a prize promotion within a game, yet it is only available to gamers of a certain demographic and territory. Every participate receives an offer and points for playing the clothing store's promotion. Players can purchase the clothing store's product in the GO4 app to receive more loyalty points. Those who score the highest on the game win the grand prize. People play for prizes from their favorite sponsors for free, and the clothing store is only charged when someone plays for their prize. Both the consumer and the brand win on this platform.

Another object of the invention is the PBGP integrates currencies and events within a normal mobile video game. The integration can include currencies such as game credits to enter prize promotions and loyalty points to redeem for real prizes. The platform also can feature an event menu which displays one or multiple sponsored events, an offer library which stores offers from advertisers, a wallet which stores prizes or purchase vouchers, and/or an online store to make purchases.

Another object of the invention is to provide a means to advertise during tournaments to generate brand and sponsors consumer awareness. For example, in the scenario mentioned above, users can allow their tournament (along with their brand logo) to be showcased across multiple games. Another object of the invention is to provide a means to remote monitoring of multiple games for revenue, promotion results, and maintenance. The GO4 app allows users to connect and network to multiple gaming platforms, monitor any tournaments, and maintain any issues that arise during said tournaments.

Another object of the invention is to offer gameplay reward options. For example, one merchant can offer digital discount coupons, another vendor can offer digital tokens and other merchants can offer popular block chain tokens. This strategy can incentivize all types of players to participate and frequent participating stores.

Another object of the invention is to collect analytic data and performs trend analysis using artificial intelligence (AI) to allow for customers to be directed at the retail stores. The GO4 app can collect tournament data over time and predicts which games direct more customers to online stores than others. This type of AI can inform vendors to make more lucrative choices when organizing events. For example, the AI learns that males play PUBG more than females. When an online men's clothing store develops a tournament for game apps, the AI recommends connecting with PUBG games to allow the vendor to reach their target audience.

Another object of the invention is targets players with promotional messages. After gamers participate in a tournament, the app can send gamers advertiser's messages in the form of emails and text messages regarding tournament results and upcoming events.

Upon a reading this disclosure, those ordinarily skilled in the art will recognize various means for carrying out these intended features of the invention. As such, it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those ordinarily skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the PBGP.

FIG. 2 shows a representative view of the PBGP's operations.

FIG. 3 shows an example of optional block chain features.

FIG. 4 shows a representative view of the PBGP's method.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

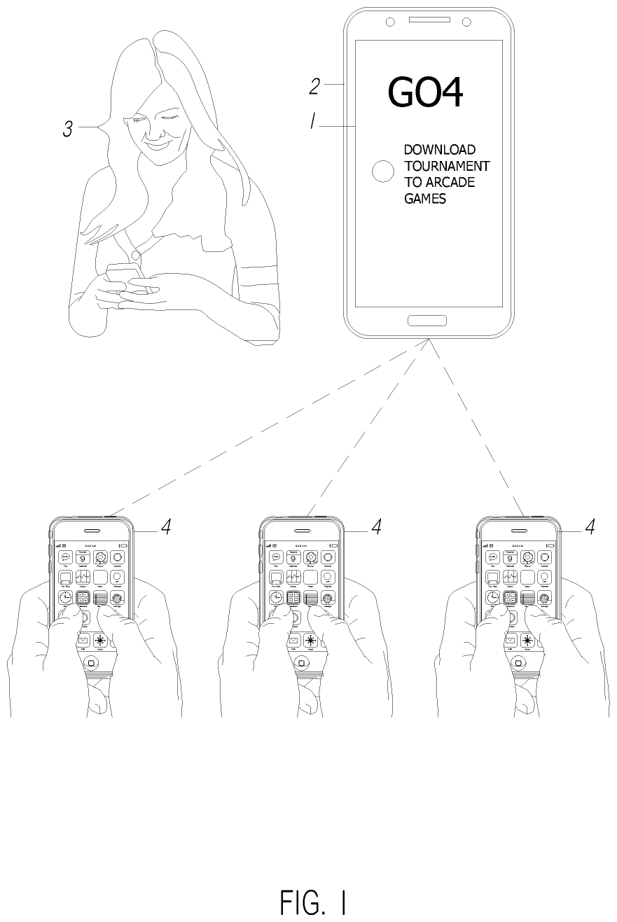

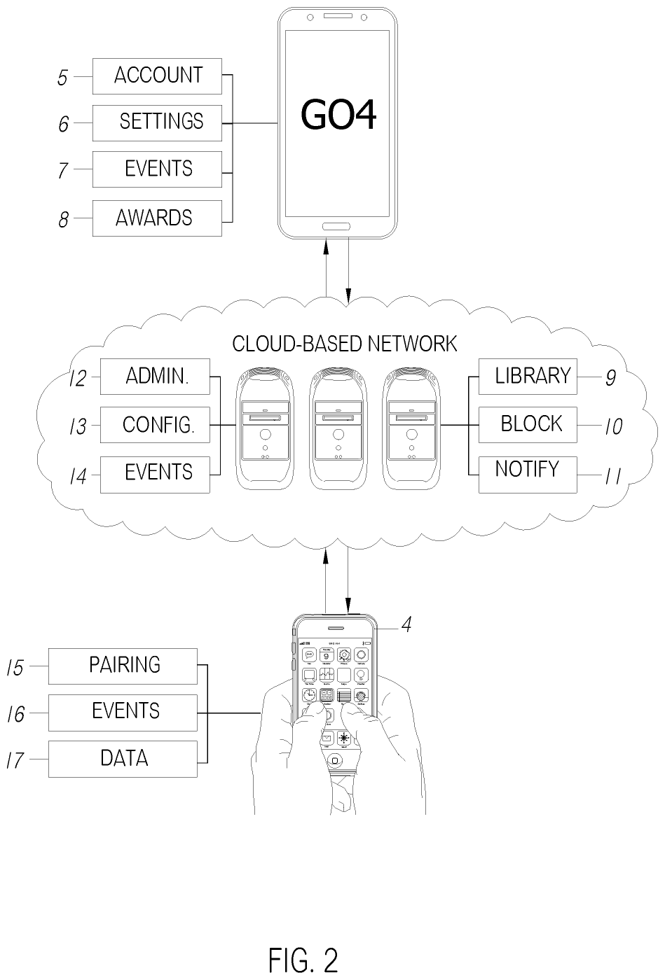

FIG. 1 shows a preferred embodiment of the PBGP comprised of a GO4 software app 1 operating system on a smartphone 2 being operated by user 3 and networking with a plurality of games such as console, PC, arcade and app 4 etc. FIG. 2 shows a representative view of the invention's functions wherein GO4 app 1 having operations that include but are not limited to: account information 5 (subscriptions, demographics, payments etc.); settings 6 (selecting console games etc.); creating events 7 (tournaments, schedules, promotions etc.); and issuing rewards 8 (tokens, discounts etc.) being operated on a mobile device that includes but is not limited to a smart phone, tablet, laptop etc. The app gamers having operations such as but not limited to: pairing with gaming apps 15 (local and/or wide area networks, Wi-Fi, etc.); event activities 16 (high scores, record keeping etc.); and data transmission 17 (winners, statistics, maintenance etc.). The user's mobile device and gaming apps being connected by means of cloud-based network having routines that include but are not limited to: administrative functions 12 (user data, financials, etc.); gaming app configurations 13 (parings, machine type, etc.); event setups 14 (tournament logistics, calendars, participant lists etc.); library files 9 (encrypted event records etc.); optional block chain operations 10 (tokens, wallets, hashing etc.) and notifications 11 (email, SMS, text messages etc.).

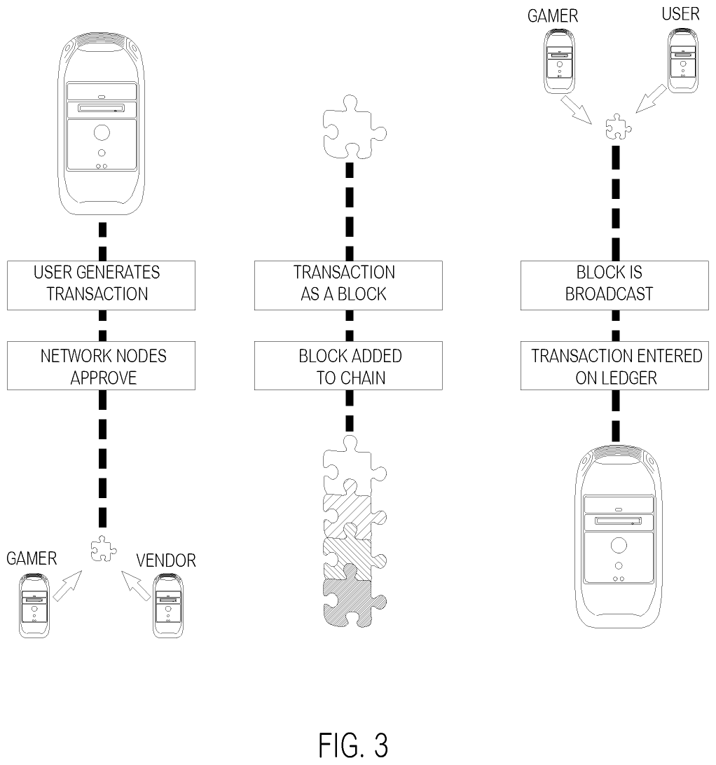

FIG. 3 shows an optional embodiment of the app having block chain software recognizes the initial transaction and it is registered as a genesis block after being approved by network nodes made up of but not limited to: vendors, and gamers etc. When a gamer participates in a tournament, each score is tabulated as a transaction being is encrypted and added to the previous block forming a hashed block chain wherein each transaction has a timestamp and metadata that is broadcast to said authorized stakeholders as a recorded transaction and being available only on the cloud network. By design, a block chain is resistant to modification of the data. For use as a distributed ledger, the block chain is typically managed by a peer-to-peer network, collectively adhering to a protocol for inter-node communication and validating new blocks. Once recorded, the data in any given block cannot be altered retroactively, without alteration of all subsequent blocks, which requires consensus of the network majority. Combined with smart contracts, such block chains can be considered as a decentralized notary service that allows for transparency so that anyone with preset privileges can see what is inside a data element record constructed using cryptographic hash and time stamped. Smart contracts are dynamic, live contracts that once created cannot be changed but can perform certain actions when certain conditions are met-such as sharing records automatically with pre-approved parties using digital signatures. FIG. 3 showing the optional blockchain embodiment with the notification process as gamers and vendors are notified of said scores posted on the cloud interface on smart phones and desktop computers etc.

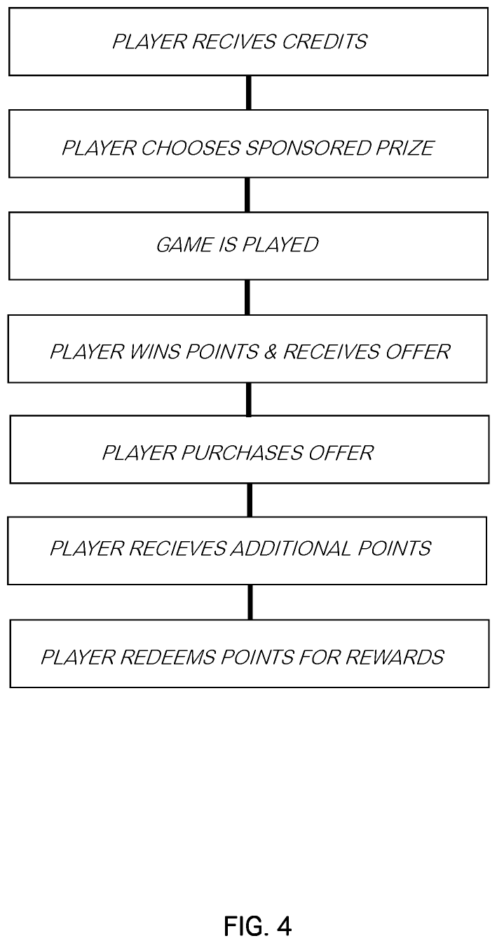

FIG. 4 shows a representative view of the PBGP's method with steps that include but are not limited to: players receive a certain number of credits to play in promotions daily from a vendor; player chooses their favorite game to play and vendor establishes a reward (digital tokens etc.); player participates in a game, and if they win the receive a prize of their choosing; player can purchase a product from the vendor and the GO4 app pays the vendor a share of said reward; player gets points for participating in the game promotion and the purchasing the offer (said points are good for additional goods, gift cards, etc.). FIG. 5 shows a representative view of the PBGP's workflow. FIG. 6 shows an example of PBGP brand options. FIG. 7 shows a representative view of the PBGP's reward method.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A performance-based gamification platform (PBGP) for multiple gaming types, including mobile devices, consoles, arcade games, and home computers, wherein the PBGP incentivizes customer awareness and enhances merchant visibility by enabling multiple commercial brands to sponsor tournaments, sweepstakes, scavenger hunts, and other promotional activities, comprising:
a) a GO4 software app on a computer-readable non-transitory storage media operating on a mobile device of a user, wherein the app facilitates account information, settings, creation of events, and issuance of rewards;
b) a plurality of gaming apps connected to the GO4 app through a cloud-based network, wherein the gaming apps enable pairing, event activities, and data transmission with the GO4 app;
c) administrative functions, gaming app configurations, event setups, library files, optional block chain operations, and notifications within the cloud-based network, enabling management, configuration, and communication between the GO4 app, gaming apps, and authorized stakeholders; and
d) wherein the PBGP allows players to receive online game credits to enter brand game promotions, select their favorite sponsors, and be rewarded with prizes or offers from the sponsors after gameplay, while allowing sponsors to be charged when a player engages their game promotion or purchases their product.

2. The PBGP of claim 1, further comprising a web portal or app that enables brands to create game promotions within different games, customize promotions with prizes, offers, points, and target specific demographics or preferences, and charge brands when players engage with their promotions.

3. The PBGP of claim 1, further comprising an integration of currencies and events within a normal mobile video game, including game credits to enter prize promotions and loyalty points to redeem for real prizes, an event menu displaying sponsored events, an offer library storing offers from advertisers, a wallet storing prizes or purchase vouchers, and an online store for making purchases.

4. The PBGP of claim 1, further comprising the ability to advertise during tournaments to generate brand and sponsor consumer awareness, wherein tournaments can be showcased across multiple games.

5. The PBGP of claim 1, further comprising remote monitoring of multiple games for revenue, promotion results, and maintenance, wherein the GO4 app allows users to connect and network with multiple gaming platforms, monitor tournaments, and address issues.

6. The PBGP of claim 1, further comprising gameplay reward options, including digital discount coupons, digital tokens, or popular blockchain tokens, to incentivize player participation and frequenting of participating stores.

7. The PBGP of claim 1, further comprising the collection of analytic data and trend analysis using artificial intelligence (AI), enabling informed decisions for organizing events and directing customers to retail stores based on AI predictions and learning from historical tournament data.

8. The PBGP of claim 1, further comprising the ability to target players with promotional messages, wherein the app can send gamers advertiser's messages via emails and text messages regarding tournament results and upcoming events.

9. The PBGP of claim 1, wherein the PBGP enhances brand awareness within various gaming communities, providing a turnkey solution for advertisers to engage gamers across multiple gaming environments.
